(19) United States
(12) Patent Application Publication
(10) Pub. No.: US 2008/0288290 A1
(43) Pub. Date: Nov. 20, 2008

(54) COMPUTERIZED SYSTEM AND METHOD FOR ENHANCING HEALTH INSURANCE EXPLANATION OF BENEFITS

(75) Inventors: Earl Steinberg, Chevy Chase, MD (US); Dean Souleles, Great Falls, VA (US); Dan Heneghan, Monkton, MD (US)

Correspondence Address: MCDERMOTT WILL & EMERY LLP, 600 13TH STREET, N.W., WASHINGTON, DC, 20005-3096, US

(73) Assignee: RESOLUTION HEALTH

(21) Appl. No.: 12/040,601

(22) Filed: Feb. 29, 2008

Related U.S. Application Data
(60) Provisional application No. 60/904,389, filed on Mar. 2, 2007.
(60) Provisional application No. 60/907,254, filed on Mar. 27, 2007.

(51) Int. Cl. G06Q 40/00

(52) U.S. Cl. 705/3

(57) ABSTRACT

A system and method for generating a health insurance explanation of benefits for a patient is provided for receiving one or more adjudicated claims from a health insurance company; analyzing the one or more claims in relation to patient information stored in a patient records database; and generating a personalized message to the patient about the patient's health care based on the stored patient information and the adjudicated claims. The personalized message, applied to an EOB generation system associated with the health insurance company, forms a part of an enhanced EOB to be provided to the patient.

### CROSS REFERENCE TO RELATED APPLICATIONS

This application claims priority from Provisional U.S. Patent Application No. 60/904,389 entitled “Computerized System and Method for Enhancing Health Insurance Explanation of Benefits”, which was filed on Mar. 2, 2007, and from Provisional U.S. Patent Application No. 60/907,254 entitled Computerized System and Method for Enhancing Health Insurance Explanation of Benefits”, which was filed on Mar. 27, 2007, the entire disclosures of both provisional applications being incorporated herein by reference.

### FIELD OF THE INVENTION

This disclosure relates generally to providing explanations of benefits from an insurance provider. More particularly, the disclosure describes systems and methods for electronically providing an explanation of benefits (EOB) to a patient which provides enhanced, personalized information to the patient in addition to the normal breakdown of charges.

### BACKGROUND OF THE INVENTION

Today, much of the health care that patients receive involve health care services that are delivered by multiple health care providers. For example, one visit to the emergency room may result in services delivered by multiple doctors, laboratories, radiology departments, etc. Thus, a bill for an emergency visit might include charges for each of the doctors' services, as well as charges for laboratory services, radiology services, and any other services rendered.

After medical services are provided to an individual who has health insurance, a claim is submitted (either by the provider(s) of service or by the patient) to the patient's health insurance company. The health insurance company adjudicates the claim in accordance with the particular patient's insurance benefits and distributes payments to the service provider(s), and reimbursements to the patient, as appropriate. Regardless of whether the insurer is reimbursing the patient for payments the patient made to the service provider(s), insurers send an Explanation of Benefits (EOB) to the insured individual, usually within six weeks after receiving a claim.

The EOB typically includes a description of the service(s) for which the claims were submitted, the physician(s) and/or facilities that provided the services, the dates on which the services were provided, the amounts that were billed, the amounts the service providers are allowed to bill for each service under the patient's health insurance plan, the amounts the insurance company paid for each service to each service provider, the amounts the insurance company refused to pay for each service, and the amount the patient is responsible for paying for each service, after taking into account the patient's insurance benefits (e.g., their deductible, co-insurance, maximum annual out of pocket expenses, etc.).

The EOB is an administrative report sent to an insured individual by their insurance company that summarizes the actions taken by the insurer in response to an insurance claim and the balance due (if any) to a service provider from the insured individual, given that individual's health insurance policy. Because it is an administrative report, an EOB does not generally contain information that would educate the patient regarding the potential health benefits and risks of the services that were provided, alternative services that would have been at least as safe and effective yet less expensive for the patient, or other services that might be of benefit to the patient or that might be needed by the patient in the future in light of the services for which they submitted claims.

Recently, there has been increased interest in providing people with information and decision-making support that would help those individuals take better care of their health, to be more discriminating and more cost-conscious with regard to the healthcare services they receive, and more generally, to play a more meaningful role in the decision making regarding the health care they receive. Moreover, with the popularity and efficiency of electronic communications (e.g., email, internet), it is highly desirable to be able to provide such information to patients via electronic communication channels as an alternative to a hard copy sent through the mail.

### SUMMARY OF THE INVENTION

The present disclosure is directed to an enhanced EOB system and method for providing enhanced EOBs that not only include information related to which services were delivered by particular healthcare providers, the fee for each service, and the portion of the fee that is to be paid by the insurance company versus the insured individual, but also include health related messages designed to educate the patient regarding potential health benefits and risks of the services which were provided, alternative services that could have been offered, other services that might benefit the patient in the future, ways the patient might reduce their out of pocket expenditures in the future, and/or other health and healthcare related information. The additional information included in the enhanced EOB may be integrated directly into a standard EOB or may accompany the standard EOB.

A system is provided for generating an enhanced EOB which comprises a database containing information related to a patient's medical history, one or more data processing modules for identifying one or more patient characteristics, and a personalized message generation module for creating personalized messages regarding the patient's health and/or healthcare to be included in or sent with the EOB

A method for generating an enhanced health insurance EOB is provided comprising receiving one or more adjudicated claims from a health insurance company, analyzing the one or more claims in relation to the patient information stored in a patient record database, generating a personalized message to the patient about the patient's health and/or healthcare based on the patient information and the adjudicated claim, and providing the personalized message to an EOB generation system associated with the health insurance provider, wherein the personalized message forms a part of the enhanced EOB or is sent along with the EOB.

### BRIEF DESCRIPTION OF THE DRAWINGS

FIG. 1 depicts a typical operational framework for generating explanation of benefits (EOB)

FIG. 2 depicts a typical EOB.

FIG. 3 depicts an overall block diagram of a system for generating an enhanced EOB.

FIG. 4 depicts an example of rules which may be used in generating an enhanced EOB.

FIG. 5 depicts an operational framework for generating an enhanced EOB.

FIG. 6 depicts an example of an enhanced EOB.

### DETAILED DESCRIPTION

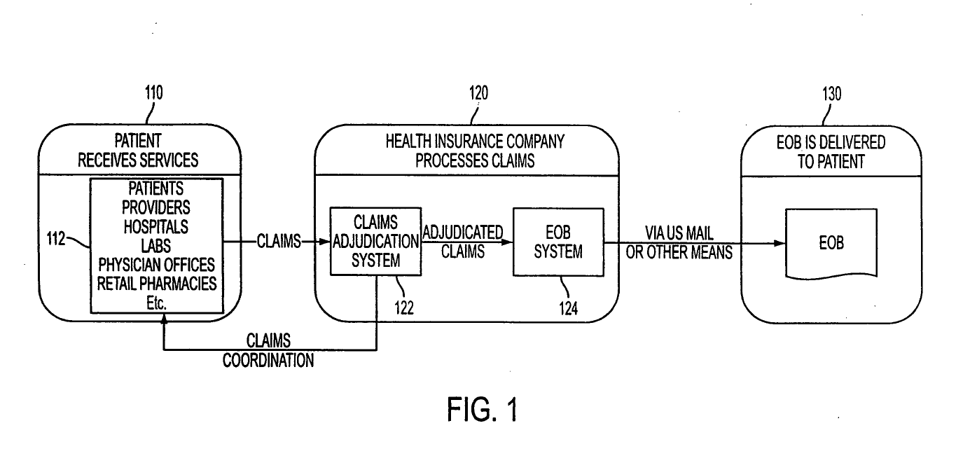

FIG. 1 depicts a simplified view of the model currently used in providing EOBs to insurance beneficiaries. As depicted at 110, a patient may receive services from a plurality of service providers 112. These service providers may include, for example, hospitals, labs, physician offices, pharmacies, etc. One or more claims is then made for payment for the services rendered. Claims may be made directly by the patient in the event the patient has already paid for the services, or by any one or more of the service providers 112.

As depicted at 120, the patient's health insurance company processes the claims. This may include, for example, an adjudication process performed by a claims adjudication system 122. The claims adjudication system 122 determines how the claim is to be paid based on the patient's insurance policy.

Once the claim has been adjudicated and the appropriate disposition of the claims is determined, the fully adjudicated claim is sent to the insurance company's EOB generation system 124 to generate an EOB. The EOB provides an explanation to the patient of how the claims were or are to be paid. The EOB may then be provided to the patient, as depicted at 130.

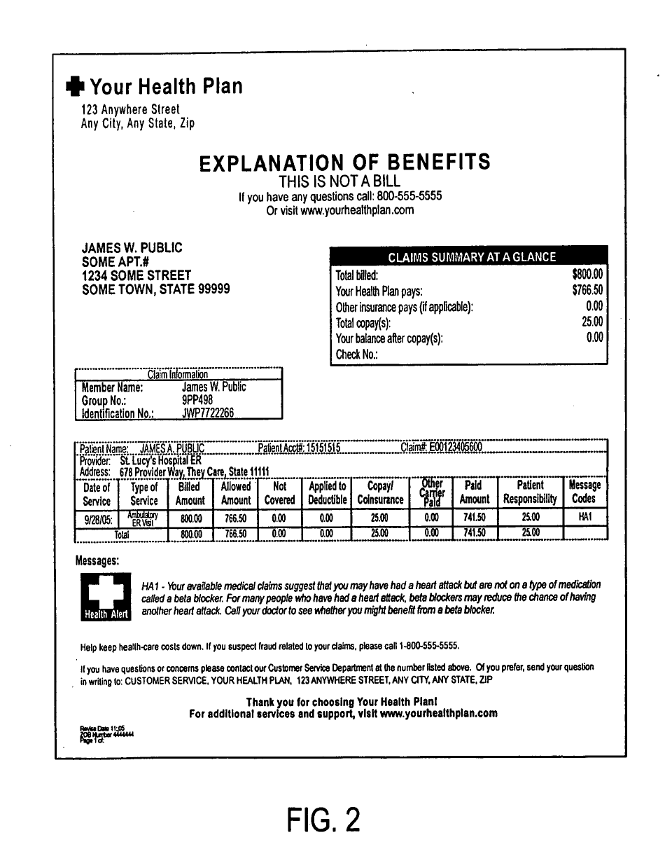

FIG. 2 depicts an example of a typical EOB. The EOB may include information regarding each claim addressed in the EOB, including the identity of the service provider, date of service, type of service, billed amount, amount allowed under the insurance plan, the amount that is not covered, the amount applied to the deductible, if any, the patient's co-payment or coinsurance amounts, amounts paid by other insurers, the amount the insurance company actually paid, and/or the amount the insured individual is responsible for paying. The EOB may also include a summary statement and/or a check to reimburse the patient for out-of-pocket costs incurred by the patient that are covered by the insurance plan.

Providers of pharmacy benefits may also include additional information in the EOB related to alternative medications that would be appropriate for the individual and available at lower cost based on the patient's pharmacy benefits, the availability of drugs at a lower cost via mail order, or educational material related to the prescription drugs for which there are claims on the EOB. The data elements required to produce such additional information are those that are readily available in the pharmacy benefit management company's data processing systems, including the medications for which claims have been submitted and the individual's benefit plan, including which prescription drugs are covered at what payment level(s), as well as educational information regarding particular medications that is available from other databases.

In accordance with various exemplary embodiments, an enhanced EOB system is provided which produces enhanced EOBs including not only the information related to billing and provided services, but also health related messages designed to educate the patient regarding potential health benefits and risks of the services which were provided, alternative services that could have been offered, other services that might benefit the patient in the future, ways the patient might reduce their out of pocket expenditures in the future, and/or other health or healthcare related information. In some embodiments, the EOB may be delivered to the patient electronically, via email or a predetermined web portal.

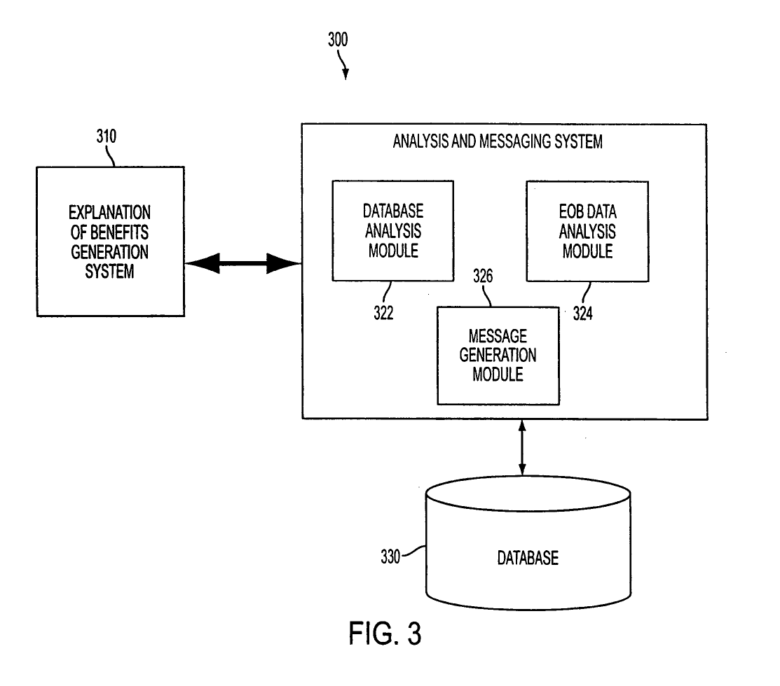

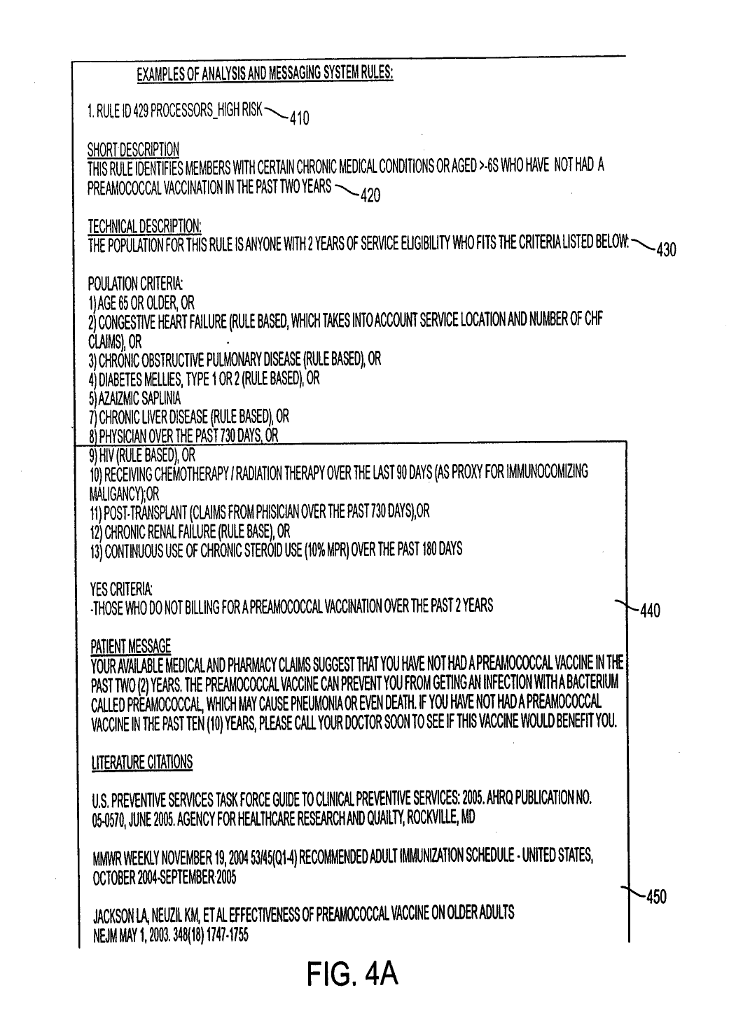

FIG. 3 depicts a simplified block diagram of a system 300 for generating enhanced EOBs. System 300 may include an EOB generation system 310 communicatively coupled to an analysis and messaging system 320. EOB generation system 310 may be any EOB generation system used by health insurance providers. The EOB generation system 310 may be modified to include an interface to the analysis and messaging system 320, enabling information to be exchanged between the two systems to create the enhanced EOB. Analysis and messaging system 320 may also interface to one or more databases 330, the databases storing patient-specific healthcare claims, personal information regarding the patient and their insurance benefits, and/or other information.

Analysis and messaging system 320 may include one or more modules for generating the data to be included in an enhanced EOB. The module or modules may include, for example, a database analysis module 322, an EOB data analysis module 324, a message generation module 326, and/or other modules.

Database analysis module 322 may be configured to retrieve and analyze data stored in database 330. For example, database analysis module 322 may be configured to retrieve patient record information from the database, including a history of claims submitted by or made on behalf of the patient, procedures and diagnoses previously received by the patient, the patient's demographic information, and/or other codified data. This data, combined with the data retrieved by the EOB data analysis module 324, may be used to provide personalized health information to be included in or sent along with a patient's EOB.

Patient records retrieved from database 330 may include several types of data, such as, for example, healthcare administrative data, clinical data, health risk assessment (HRA) or health status assessment (HSA) data, provider feedback, and/or other types of data. Healthcare administrative data may include data such as member demographics, health insurance eligibility information, data related to medical/pharmaceutical claims made in the past, provider demographic data, etc. In some instances, this data is provided directly by the patient or by the insurance plan manager.

Clinical data may include diagnostic laboratory results, biometric data, and/or other clinical data. This data may be provided directly from the lab providing the services and may be included as part of a submitted claim. Lab test results, which may be reported in the form of Logical Observation Identifiers Names and Codes (LOINC), as well as the dates of services may be included in the clinical data. Biometric data (e.g., blood pressure, height, weight, etc.) may be reported directly from the digital device collecting the data, or may be reported by the physician or other care manager.

HRA/HSA information may be self-reported by the patient or provided by a physician's office. For example, a patient may complete a survey about their health history, personal habits, family history, allergies, conditions/medications, etc. Providers may also provide feedback on a patient's conditions and services rendered.

EOB data analysis module 324 may be configured to retrieve adjudicated claims from EOB generation system 310. The EOB data analysis module 324 analyzes the data from the adjudicated claims to determine, for example, which procedures a patient has received, any medications that were prescribed, any lab reports, and/or any other data related to the patient's care. In some embodiments, the EOB data analysis module 324 also analyzes the charges applied for the patient's services as well as the amount paid by the insurance company. This enables the EOB data analysis module 324 to suggest ways the patient may save money in the future.

Message generation module 326 may be configured to generate one or more personalized messages to be included in or with a patient's EOB. The personalized message may take into account the patient's medical history, based on the data retrieved and analyzed by the database analysis module 322. Additionally, the personalized messages may relate to the EOB data provided to the EOB data analysis module 324.

A plurality of rules may be configured which indicate the type of personalized messages which should be provided to the patient in or with the EOB. In some embodiments, rules may be created which determine the type of message to be provided to a patient based on a plurality of factors. Factors may include, for example, the services received by the patient, the patient's medical history, demographic information such as the patient's age, race, or weight, etc. Rules, may be organized, for example, based on common medical conditions/treatments.

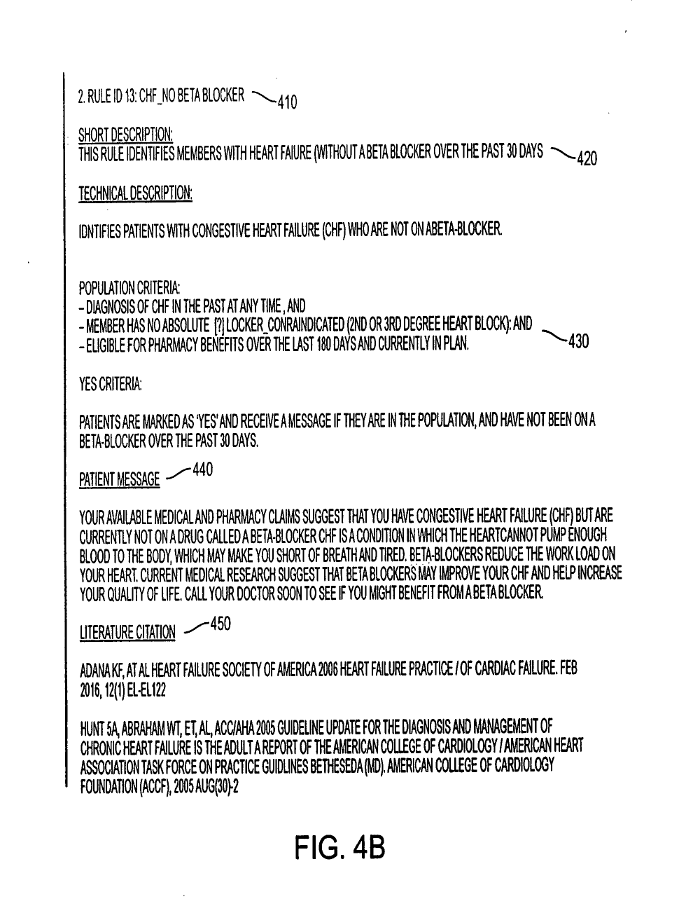

FIG. 4 depicts two examples of rules which may be defined. Each rule includes a rule identifier 410, a short description 420, a technical description 430, a patient message 440, and citations 450 to literature related to the patient message. Other information may be included. The short description 420 provides a brief overview of what the rule applies to. For example, rule 1 relates to pneumococcal vaccinations while rule 2 relates to patients who have heart failure but are not taking a beta blocker.

The technical description 430 defines the criteria used to determine whether a patient should receive a message related to this rule. The rule may define whether the patient has to meet one or more of the predefined criteria in order to receive the message associated with the rule. The patient message 440 is the message to provided to the patient in or with the EOB. Literature citations 450 may be provided to give the patient additional background information on the treatments or services recommended or described in the patient message. In some embodiments, the referenced literature may be provided to the patient with the EOB. For example, for an electronically transmitted EOB, a link to the literature may be provided.

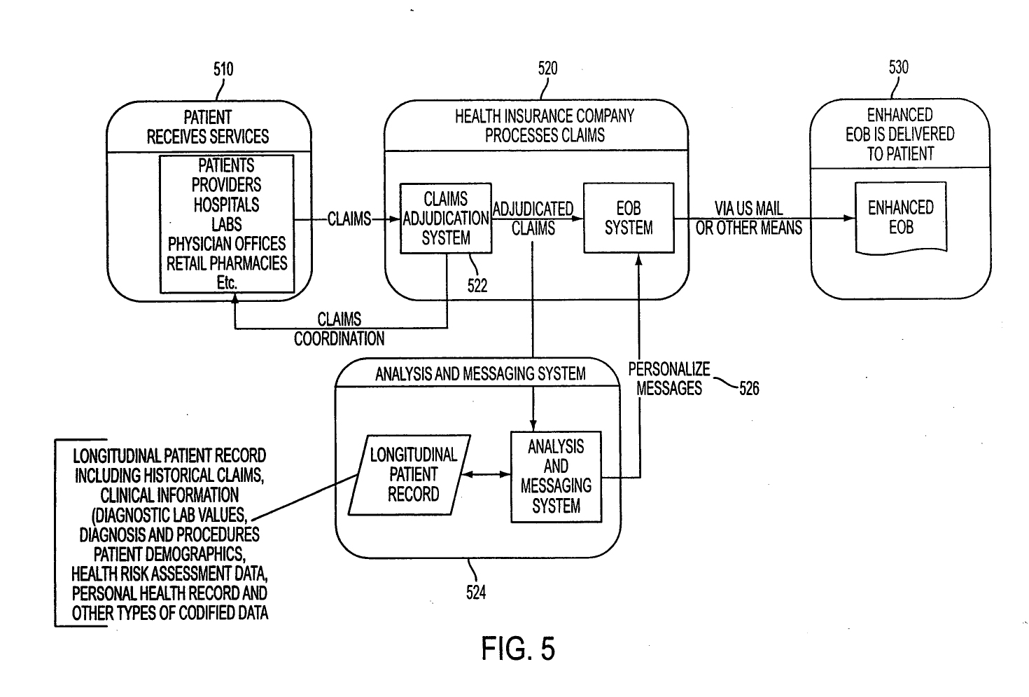

FIG. 5 depicts an overall method for producing enhanced EOBs. As depicted at 510, the patient may receive services from providers such as hospitals, labs, physicians, pharmacies, etc. As depicted at 520, the patient's health insurance company receives and processes the insurance claims. This may include a claim adjudication process performed by claim adjudication system 522. The adjudicated claims are then submitted for processing by the analysis and messaging system, as depicted at 524.

The analysis and messaging system retrieves the patient's medical history from a patient database and uses this information, along with the adjudicated claim information, to generate a personalized message to be included in or with the EOB. As depicted at 526, the personalized message is transmitted to the EOB system for inclusion in or with the EOB. The new, enhanced EOB is then provided to the patient, as depicted at 530. The EOB may be provided to the patient via U.S. mail, electronic mail, facsimile, via a dedicated web portal, and/or any other transmission means.

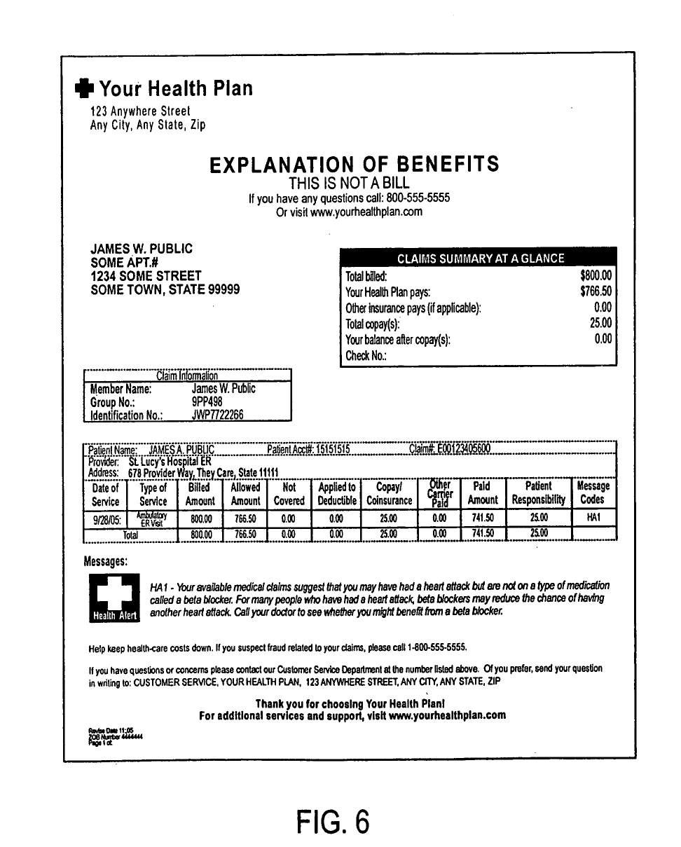

FIG. 6 depicts an example of an enhanced EOB which may be generated in accordance with the systems and methods described herein. The enhanced EOB includes a health alert, which provides a personalized message to the patient. In this case, it is recommended that the patient speak with a doctor to determine whether the patient might benefit from a beta blocker.

The processes and methods described herein may be implemented in hard wired devices, firmware, or software running in a processor. Any of these processes may be contained on a computer readable medium. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals. Those of skill in the art will appreciate that a computer readable medium may carry instructions for a computer to perform the methods described herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A system for generating an enhanced health insurance explanation of benefits for a patient comprising:
a database containing information related to the patient;
one or more data processing modules for identifying one or more patient characteristics based on the information related to the patient; and
a personalized message generation module for creating one or more personalized messages to be included in or with the explanation of benefits.

2. The system of claim 1, wherein the information related to the patient includes one or more of the patient's historical insurance claims, demographics, and personal health records.

3. The system of claim 1, wherein the one or more data processing modules include:
a benefits information processing module for retrieving data related to one or more claims for which the explanation of benefits is being prepared; and
a database analysis module for determining, based on the retrieved claim data and patient record information patient stored in the database, one or more patient characteristics.

4. The system of claim 1, wherein the personalized message generation module creates the one or more personalized messages based on a plurality of predefined rules.

5. The system of claim 5, wherein each of the predefined rules includes a plurality of criteria used to determine whether a patient should receive the personalized message associated with the rule.

6. The system of claim 4, wherein each of the predefined rules comprises a technical description of the type of patient the rule applies to.

7. The system of claim 4, wherein each of the predefined rules includes or is associated with the personalized message to be provided to the patient if the rule is triggered.

8. The system of claim 3, wherein the benefits information processing modules retrieved the data related to one or more claims from the patient's insurance provider's EOB generation system.

9. The system of claim 3, wherein the database analysis module is configured to retrieve, from the database, the patient record information.

10. A computer-implemented method of generating an enhanced health insurance explanation of benefits (EOB), comprising:
receiving one or more adjudicated claims from a health insurance company;
analyzing the one or more claims in relation to patient information stored in a patient records database;
generating a personalized message to the patient about the patient's health or healthcare based on the stored patient information and the adjudicated claims; and
providing the personalized messaged to an EOB generation system associated with the health insurance company,
wherein the personalized message forms a part of or is sent together with the enhanced EOB to be provided to the patient.

11. The computer-implemented method of claim 10, wherein the patient information includes one or more of the patient's historical insurance claims, demographics, and personal health records.

12. The computer-implemented method of claim 10, wherein the personalized message includes information related to improving the patient's health.

13. The computer-implemented method of claim 10, wherein the personalized message includes information related to reducing the patient's costs.

14. The computer-implemented method of claim 10, wherein the enhanced EOB is provided to the patient by electronic mail.

15. The computer-implemented method of claim 10, wherein the enhanced EOB is provided to the patient via a dedicated web portal.
